(19) United States
(12) Patent Application Publication
(10) Pub. No.: US 2016/0322119 A1
(43) Pub. Date: Nov. 3, 2016

(54) Least action nuclear processes and materials

(71) Applicant: Daniel S. Szumski, Davis, CA (US)

(72) Inventor: Daniel S. Szumski, Davis, CA (US)

(21) Appl. No.: 14/544,169

(22) Filed: Dec. 3, 2014

Related U.S. Application Data
(63) Continuation-in-part of application No. PCT/US2012/000265, filed on Jun. 4, 2012.

(51) Int. Cl. G21B 3/00; G21F 9/00; G21G 1/00

(52) U.S. Cl. CPC G21B 3/002; G21G 1/00; G21F 9/00

(57) ABSTRACT

Methods for loading hydrogen and hydrogen isotopes into a metal hydride lattice are described. Additionally, methods for using such a lattice to stimulate nuclear transformations, whether for energy production, specific isotope production or specific isotope consumption are described. Further, compositions of matter for use in these methods are described.

### CROSS-REFERENCE TO RELATED APPLICATIONS

This application is a continuation in part of international application serial number PCT/US2012/000265, filed on Jun. 4, 2012.

### BACKGROUND OF THE INVENTION

This invention pertains to two fields of scientific endeavor: electrochemistry, and nuclear physics, and several fields of technical endeavor, including but not limited to nuclear fusion, nuclear transmutation, heat energy generation, electrical energy generation, manufacture of metal ores, and stabilization/transmutation of radioactive wastes.

Low Energy Nuclear Reactions (LENR), also referred to as ‘cold fusion’ were reported in 1989 by Stanley Pons and Martin Fleischman (4) who had conducted electrolysis experiments of heavy water at the surface of a palladium electrode. They reported that their experiments produced excess heat, and nuclear reaction byproducts. These claims were met with skepticism in the scientific community after initial attempts to replicate their experiments either failed, or resulted in sporadic confirmation. More important to peer reviewers was the perception that there was no understandable means to overcome the coulombic repulsion of the fusing atomic nuclei.

Nevertheless, when one looks carefully at the experimental record, it becomes apparent that these are not flukes or erroneous experimental results. Excess heat is indeed produced in significant quantities in many, but not all, of these experiments. It has become evident that the post-experiment electrodes demonstrate exotic isotope changes that bear little resemblance to either natural abundance ratios or contaminants (Miley ref 5). Indeed, Szumski (1) has shown that it is possible to predict nuclear transmutations with the precision of physics using the LANP method.

One of the commonly cited shortcomings of the LENR experiments is that sometimes there is no excess heat production at the experiment's level of significance, and the experiment is considered a failure. LANP shows that both exothermal and endothermal reactions occur in these electrolysis experiments, and that excess heat occurs when exothermal processes predominate. Thus, the null result of producing no excess heat merely encompasses one of the valid LANP outcomes, as do experiments that produce different excess heat amounts.

LENR and Cold Fusion experiments are being conducted worldwide by experimentalists, and persons seeking to develop commercial applications of the technology. They observe anomalous excess heat by the interaction of hydrogen or deuterium on electrodes made of palladium, nickel, and platinum, however, this work is still largely dismissed because, although a variety of experimental designs do produce excess heat and nuclear transmutations, there is no theory that explains the underlying process.

The arguments against the types of nuclear processes that have been claimed include the following. The repulsive forces between positively charged reactants, specifically deuterons, are large, requiring solar core like temperatures and pressures to bring deuterium nuclei close enough to undergo fusion. Cold fusion was unlikely because the spacing between deuterium or hydrogen nuclei in a metal lattice is thought to be greater than that in the condensed gas state. Secondly, expected reaction products are not present. In particular, the experiments sometimes produce ⁴He, but without the gamma radiation in the known two step reaction:

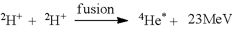

Where ⁴He* is an excited nuclear state of helium that decays as:

⁴He*→⁴He+γ+24 MeV

In fact, experiments have shown that there are no radioactive products formed in LENR devices, and no gamma radiation.

Several other issues that cloud the LENR landscape are summarized as follows:
1. The long time delays between initiation of electrolysis and excess heat production are unexplained.
2. Why no excess heat is sometimes the experimental outcome.
3. The mode of energy storage or energy triggering in the lattice is unknown.
4. How the required energy peaks occur is unknown.
5. Nuclear transmutation occurring in the electrode follows no apparent systemization.
6. Shifts from natural abundance are unexplained.
7. The mechanistic process giving rise to new nuclei is unknown.

There have been many attempts to explain LENR experiments using various types of theoretical frameworks. These invariably fail to explain more than one or two of the observed effects, and for this reason theory is the single weakest element of LENR claims.

In light of these problems, there is a need for an internally consistent theoretical framework of the LENR process, as well as means to predict products, increase preferred reactions such as: increasing heat production, increasing production of desired isotopes, or increasing the consumption of unstable waste isotopes.

### BRIEF SUMMARY OF THE INVENTION

In one aspect, the invention comprises a method of loading hydrogen in any of its isotopic forms into a metal hydride lattice.

In another aspect, the invention comprises a method of loading hydrogen into a metal hydride lattice, wherein the resulting concentration of hydrogen within said metal hydride lattice is greater than could be loaded into a metal hydride lattice by naturally occurring metal hydride formation.

In another aspect, the invention comprises a method of stimulating nuclear transmutation within a metal hydride lattice which has a concentration of hydrogen within said metal hydride lattice that is greater that could be loaded into a metal hydride lattice by naturally occurring metal hydride formation, by applying an electric current to said lattice.

In another aspect, the invention comprises a method of generating heat energy by applying an electric current to a metal hydride lattice which has a concentration of hydrogen within said metal hydride lattice that is greater that could be loaded into a metal hydride lattice by naturally occurring metal hydride formation, wherein said heat energy is produced in excess of the electrical energy applied to said metal hydride lattice.

In another aspect, the invention comprises a method of decreasing the concentration of specific isotopes within a metal hydride lattice which has a concentration of hydrogen within said metal hydride lattice that is greater that could be loaded into a metal hydride lattice by naturally occurring metal hydride formation, wherein said decrease in concentration of specific isotopes is effected by applying an electric current to said metal hydride lattice.

In another aspect, the invention comprises a method of increasing the concentration of specific isotopes within a metal hydride lattice which has a concentration of hydrogen within said metal hydride lattice that is greater that could be loaded into a metal hydride lattice by naturally occurring metal hydride formation, wherein said increase in concentration of specific isotopes is produced by applying an electric current to said metal hydride lattice.

In another aspect, the invention comprises a method of generating heat energy by applying an electric current to a metal hydride lattice which has a concentration of hydrogen within said metal hydride lattice that is greater that could be loaded into a metal hydride lattice by naturally occurring metal hydride formation, wherein said heat energy is produced in excess of the electrical energy applied to said metal hydride lattice and wherein said metal hydride lattice has been doped with nuclear isotopes that enhance exothermic reactions.

In another aspect, the invention comprises a method of decreasing the concentration of specific isotopes within a metal hydride lattice which has a concentration of hydrogen within said metal hydride lattice that is greater that could be loaded into a metal hydride lattice by naturally occurring metal hydride formation, wherein said decrease in concentration of specific isotopes is effected by applying an electric current to said metal hydride lattice and wherein said metal hydride lattice has been doped with nuclear isotopes that enhance said specific isotope reductions.

In another aspect, the invention comprises a method of increasing the concentration of specific isotopes within a metal hydride lattice which has a concentration of hydrogen within said metal hydride lattice that is greater that could be loaded into a metal hydride lattice by naturally occurring metal hydride formation, wherein said increase in concentration of specific isotopes is produced by applying an electric current to said metal hydride lattice and wherein said metal hydride lattice has been doped with nuclear isotopes that enhance said specific isotope production.

In another aspect, the invention comprises a metal hydride lattice wherein the concentration of hydrogen within said metal hydride lattice is greater that could be loaded into a metal hydride lattice by naturally occurring metal hydride formation.

In another aspect, the invention comprises a metal hydride lattice wherein the concentration of hydrogen within said metal hydride lattice is greater that could be loaded into a metal hydride lattice by naturally occurring metal hydride formation and wherein said lattice has been doped with nuclear isotopes which enhance exothermic reactions when an electrical current is applied to said lattice.

In another aspect, the invention comprises a metal hydride lattice wherein the concentration of hydrogen within said metal hydride lattice is greater that could be loaded into a metal hydride lattice by naturally occurring metal hydride formation and wherein said lattice has been doped with nuclear isotopes which enhance specific isotope production when an electrical current is applied to said metal hydride lattice.

In another aspect, the invention comprises a metal hydride lattice wherein the concentration of hydrogen within said metal hydride lattice is greater that could be loaded into a metal hydride lattice by naturally occurring metal hydride formation and wherein said lattice has been doped with nuclear isotopes which enhance specific isotope reduction when an electrical current is applied to said metal hydride lattice.

### BRIEF DESCRIPTION OF THE DRAWINGS

FIG. 1—Illustration of non-equilibrium changes in the heat radiation spectra. Equilibrium represents the steady state case predicted by Planck's Equation and by Szumski's equation, where the thermodynamic and radiation temperatures are identical. Case A represents instantaneous mass domain heating (i.e. friction) at constant radiation temperature. Case B represents adiabatic heat accumulation at a constant thermodynamic temperature. In this case, the radiation temperature increases by storing energy internally in covalent bonds and Mossbauer resonance between nuclei, but always at the prevailing thermodynamic temperature that the observer sees. This is the fundamental physics underlying LANP. There are very small differences between Planck's result and Szumski's equilibrium result. These may be true differences that give rise to other fundamental process in nature, or the differences may be artifacts of an improper derivation of Szumski's equation. However, these differences in no way diminish the concepts or processes described in this application.

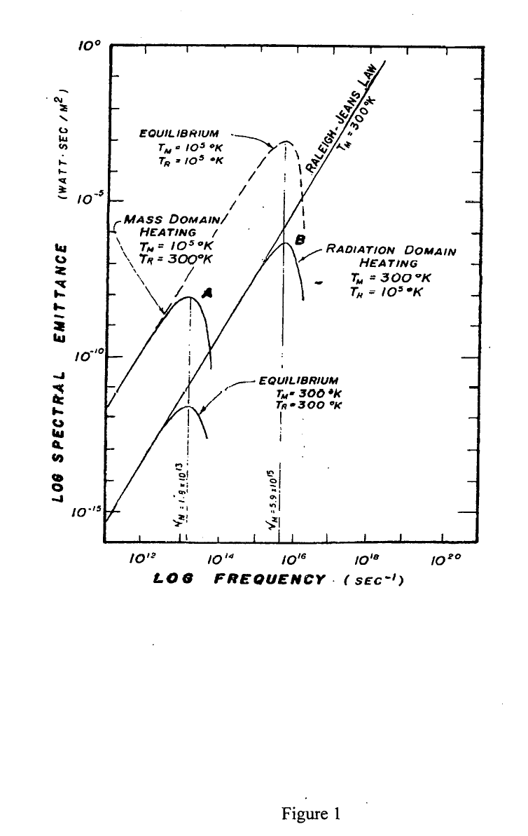

FIG. 2—Contrasts the temperature regimes (Tₘ and T_{R}) that Szumski's theory postulates in the solar core, with that in an LANP device. The drawing suggests that the peak blackbody spectral energy required for ignition in the Tokamak is about four orders of magnitude greater than that operative in the F&P cell. The total energy, measured as the area beneath any curve, indicates an even greater difference. In essence, the LANP process takes an energy shortcut around the enormous energy of thermal motion required for thermonuclear fusion, but still operates at solar core temperatures measured instead by T_{R}.

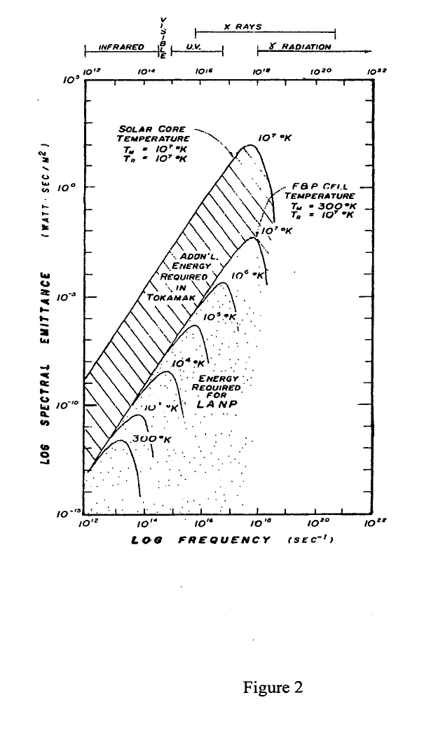

FIG. 3—Comparison of the known decay sequence resulting from the nuclear reaction:

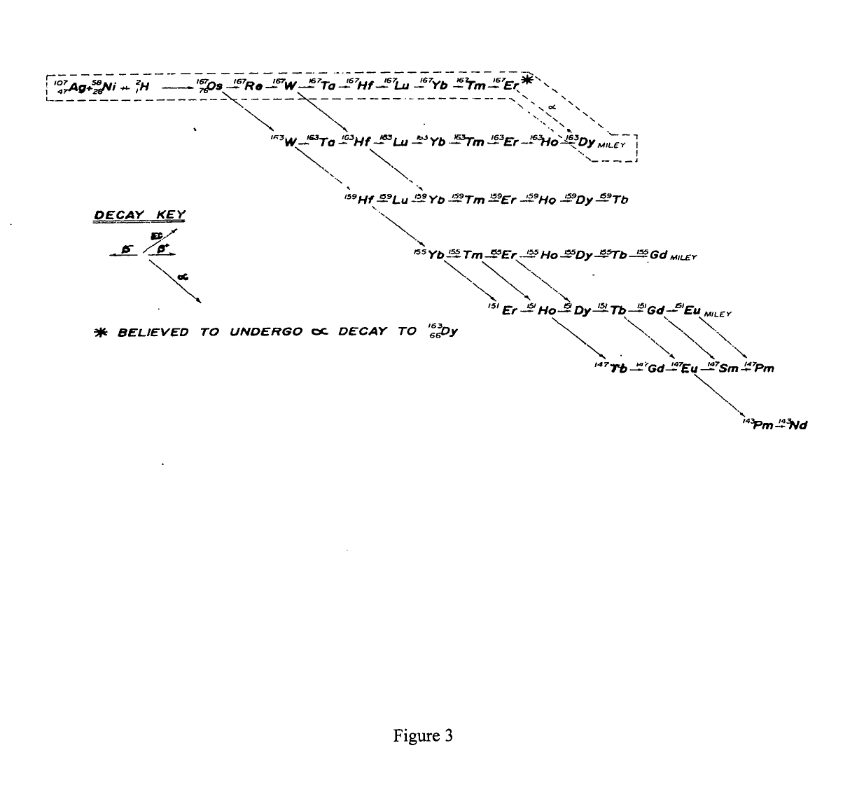

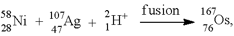

with the LANP decay path. The Least Action decay is to ₆₈¹⁶⁷Er with subsequent alpha decay to ₆₆¹⁶³Dy. However, the decay to ₆₆¹⁶³Dy occurs as a single step without any radioactive intermediates, and without any of the normal half-life decays.

FIG. 4—a representation of the reversible and irreversible steps in the absorbtion of a photon by an electron.

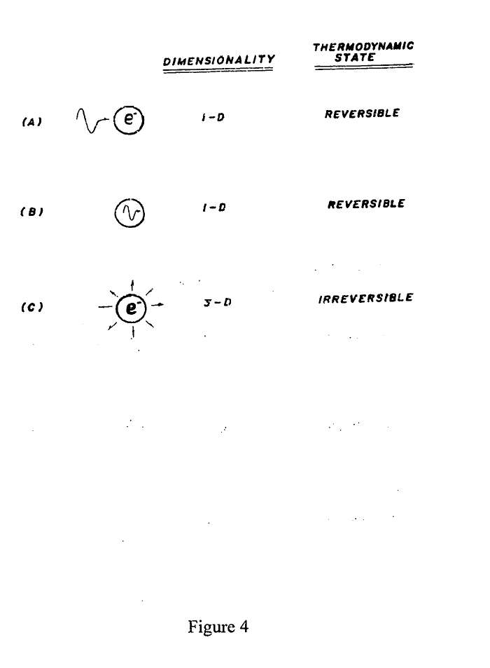

FIG. 5—shown the comparison between the spectral emmittance curves predicted by Plank's equation and the emmitance curves predicted by Szumski.

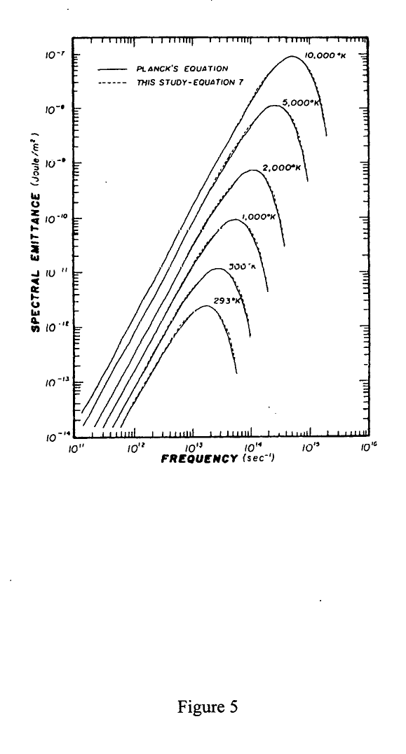

### DETAILED DESCRIPTION OF THE INVENTION

### Definitions

In this application, the following definitions will be utilized:
Candidate(s) Any of the possible nuclear reactions in the metal hydride lattice that are thermodynamically feasible at any next step in the LANP process.
Covalent electrons Two electrons sharing bond energy in a reversible thermodynamic manner.
Doping Intentionally introducing impurities into a lattice in order to modify the reaction characteristics of said lattice.
Endothermal heat energy consumption or utilization by a physical process.
Excess energy The amount of energy derived from the LANP process minus the amount of energy input to the process over a specific time interval.
Exothermal Refers to heat energy production or release by a physical process.
Harvest The process by which the kinetic energy of a hydrogen species is absorbed into a metal lattice.
Heat budget A running summation of heat production and consumption.
Hydrogen Includes forms of the element hydrogen all of which have a single proton, and a neutron count of: zero (¹H), one (²H), or two (³H); and their di-hydrogen forms: (¹H₂, ²H₂, ³H₂, ¹H²H, ¹H³H, and
Hydrogen Absorption The movement of hydrogen from the medium into a metal lattice where it forms a metal hydride.
Loading Refers to the process by which hydrogen is added to a metal hydride lattice in amounts that are higher than those occurring naturally.
Medium The hydrogen containing material surrounding a metal lattice undergoing an LANP process. For example: heavy water or hydrogen gas.
Metal hydride lattice The lattice structure of any metal that has incorporated hydrogen to form a metal hydride. Examples of such metals include palladium, nickel, and titanium.
Mossbauer resonant nuclei Two atomic nuclei sharing bond energy in a reversible thermodynamic manner.
Normal decay sequence The naturally occurring decay of an unstable isotope to its final isotope product(s).
Nuclear safe without possibility of an uncontrolled nuclear cascade Nuclear transmutation Any nuclear reaction that results in alterations to the nucleus of the parent atom(s).
Sigma decay The name given to a newly defined nuclear decay process in which the reactants that would normally form an unstable isotope, combine into a single stable isotope in accordance with the Principle of Least Action, or in this case, the least mass change.
Sigma decay is accompanied by the release or consumption of an amount of energy which is equivalent to the Least Action mass change. Sigma decay is unique to the LANP process.
Stable decay products Any of the stable isotope products resulting from the natural radioactive decay paths of a particular unstable isotope.
Temperature A derivative; the rate of energy emittance by any mass quantity expressed as joules/time.
Temporal integration. The algebraic sum of a process quantity such as heat production and consumption over time.

### DOCUMENTS INCORPORATED BY REFERENCE

The following references have been attached as appendices to this application and are herein incorporated by reference into this application:
1. SZUMSKI, D. S., Nickel Transmutation and Excess Heat Model using Reversible Thermodynamics, Unpublished manuscript, 2012.
2. SZUMSKI, D. S., Theory of Heat I-Non-equilibrium, non-quantum Blackbody Radiation Equation Reveals a Second Temperature Scale, Unpublished manuscript, 2012.
3. SZUMSKI, D. S., Nickel Transmutation and Excess Heat Model using Reversible Thermodynamics, J. Condensed Matter Nucl. Sci., 13(2014)554-564.
4. SZUMSKI, D. S., Rethinking Cold Fusion Physics: An Essay, Unpublished manuscript, 2014.
5. SZUMSKI, D. S., Cold Fusion and the First Law of Thermodynamics: An Essay, Unpublished manuscript, 2014.
6. SZUMSKI, D. S., Introduction to Theoretical Biology, a Theory of Heat, 2013, Unusual F Street Winery Press, Davis, Calif., 2013

### Least Action Nuclear Process

Least Action Nuclear Process (LANP) is a process which accomplishes both fusion and fission reactions at solar core temperatures. Nevertheless, its apparent operating temperature is generally less than 70° C. (343° K) on the scientifically accepted thermodynamic temperature scale. The fundamental difference between a device that uses the LANP, and others that have been patented to date, lies in the process that the device is designed to accomplish. Their devices are designed for low temperature nuclear reactions which take place at less than 373° K, and are claimed to produce fusion at that temperature. In other words they are relying on magic to accomplish what is impossible given the present understanding of physics and chemistry.

The LANP device on the other hand operates on principles derived from a new non-equilibrium theory of heat that includes two temperatures, both of which exist on the same Kelvin temperature scale. In particular, Szumski (1) has developed a far-from-equilibrium blackbody radiation theory having two temperature scales. The first is the thermodynamic temperature, Tₘ, which is measured by devices like thermometers and their digital descendants. Thermometers measure a derivative that we call the thermodynamic temperature, and which is most clearly understood in terms of the equilibrium blackbody theory of Planck (2). The equilibrium condition that the thermometer measures is one where the amount of heat absorption in the object being measured, is exactly equal to the emissivity, a measure of the total heat being emitted by that object. At equilibrium, the absorbed and emitted heat at the boundary of the object have identical rates(derivatives)(Planck (3)), and by assigning a temperature scale to quantify that derivative over a wide range of natural conditions science has made it possible for us to talk about the heat derivative in simple terms such as degrees Celsius, degrees Fahrenheit, and degrees Kelvin, rather than joules/sq m-sec.

Szumski's theory of heat includes a second temperature scale, which he calls the radiation temperature, denoted by the symbol T_{R}. It is also a derivative, and can be measured on the same scales as the thermodynamic temperature, but it is fundamentally different in what this derivative is measuring. It is the rate of energy flux across the boundary of a fundamental particle, and in particular, a system where that fundamental particle is sharing electromagnetic energy with another identical fundamental particles in a process described as resonant and adiabatic.

A covalent bond is such a system. Each covalent electron alternately absorbs and emits a single quanta of energy that is shared between them in an equilibrium state that is undiminished in time. This is a true reversible process. There is no recoil or other loss of energy to ‘waste’ heat of motion. In the world of physics we say that the covalent process is adiabatic. The rate of heat exchange across the boundary of either electron can still be measured in Joules/sq m-sec or degrees Kelvin. The absolute value of any one energy exchange is infinitesimal, but because the exchange takes place at the speed of light, and billions or trillions of times per second, the aggregate heat exchange across the electrons boundary (per second) tends to be large.

In the current case the exchange of energy is most likely occurring between electrons at the beginning of the LANP process when the exchanged energy is small. However, as the process proceeds, the energy exchanges become great enough that they occur between excited nuclei in a resonant process called Mossbauer resonance or the Mossbauer effect. In effect electromagnetic energy in the gamma intensity range resonates between two nuclei, without recoil or any energy loss. This is a reversible adiabatic process, as is the rest of the LANP.

The electrolysis device which is in its simplest form is a container of heavy water (or plain H₂O water) a cathode made of one of the metals (palladium, platinum, nickel, uranium, lanthanum, praseodymium, cerium, titanium, zirconium, vanadium, tantalum, hafnium and thorium). an anode, and an electrical source. The device is loaded by running it for several weeks or even months, all the time renewing the water or heavy water that is lost.

This process is called Least Action Nuclear Process (LANP) rather than the current acronym LENR because the process is fundamentally different than that envisioned by researchers working in this field over the past 24 years. In particular, those researchers believed that the process that they were studying occurred at low (laboratory) temperatures because the temperature of their electrolysis apparatus was always close to 50-60 degrees Celsius (323-333° K). This invention places the actual temperature of the nuclear reactions that are occurring at solar core temperatures, about 10⁷° K. However, this temperature, although measured on the same scale as the thermodynamic temperature, is contained internally in the cathode's metal lattice as Mausbauer Resonance between identical nuclei. In this way the real temperature of the process is masked from detection. The process that is actually occurring follows the Principle of Least Action, and for this reason, the process is called Least Action Nuclear Process.

The theory behind the LANP process begins with a new theory of heat that allows non-equilibrium and far-from-equilibrium heat processes, the latter being operative in the LANP device. The theory in-so-far as it is currently known is presented in reference (6) which develops a far-from-equilibrium blackbody equation that differs from Plank's steady state formula in important respects. First the equation reveals a second temperature scale that I have called the radiation temperature, T_{R}. The theory shows how in the LANP process, these two temperatures are separated in a far-from-equilibrium state where the thermodynamic temperature remains at the 50-60° C. thermodynamic temperature while the radiation temperature rises during the loading phase of the experiment to solar core temperatures where nuclear fusion and fission reactions are known to occur.

What makes the LANP process so special are first, the way that the nuclear reaction occurs at solar core temperatures, and even nucleosynthesis temperatures of supernovae; and secondly in the unique process by which certain nuclear reactions are selected to go forward, while all others are eliminated. The Principle of Least Action lies at the heart of this selection process. That Principle characterizes only thermodynamically reversible processes, or those that can, by adjustment of boundary conditions, be approximated as being thermodynamically reversible. The condition of reversibility requires that all of the systems energy, and most importantly, any heat of molecular motion, is available to the reaction. Under this condition, reactions that can occur do occur. The Principle of Least Action selects from all of the possible reactions that might occur in the system under consideration, the one that creates the least energy change. In this way, and at every step in the LANP process, there is one, and only one, next nuclear reaction that the overall process is evolving toward.

A peculiarity in the reaction that actually occurs is found in the way that the Principle of Least Action selects only for stable isotopes, i.e. those in their lowest energy state. The invention bypasses intermediate steps involving radioactive decay, and half life time delays. In this way, the LANP process eliminates the messy radiation signature of other nuclear processes, and makes it the ‘green alternative’ to other modes of nuclear energy production.

The LANP process produces excess heat which can be harvested and employed in human endeavors. It also mediates a wide range of predictable nuclear transmutation products that can be selected for, and ‘mined’ from the LANP residues. It is also a candidate process for the disposal of radioactive wastes. These and other LANP uses are itemized in the patent's claims.

There are five noteworthy advantageous effects of LANP, including several distinct advantages over other nuclear processes.

First, LANP is a nuclear process that, in theory, can provide an inexhaustible supply of energy for human purposes. The excess heat it produces (when it is designed to produce heat) can be converted into other electrical and chemical energy forms. It appears theoretically possible that there may even be sub-processes that consume excess heat.

Second, LANP is safe and environmentally friendly. It operates at an apparent temperature that approximates that of other industrial processes. There are no excessively high temperatures, no hot waste products, no need for cooling towers, and no need for water or air pollution controls, at least none that we are aware of at this time. The electrode recycle process may not be as benign.

Third, the LANP nuclear process is clean. It produces no radioactive waste products, and therefore eliminates the nuclear waste disposal problem. In fact, it is possible to use this process to neutralize existing radioactive wastes while producing heat for other industrial, agricultural, and domestic needs.

Fourth, LANP waste products are useful raw materials for industry. These include halogens and noble gasses, and a broad range of metals including the rare earths, and precious metals.

Fifth, the process can potentially provide extraordinary insights into new processes in physics, chemistry and biology, both for new technologies, and also new avenues for scientific inquiry. LANR has the potential to change the earth in very fundamental ways that can be good or detrimental to mankind and his society, and the ecosystem that we call home. It needs to be used responsibly.

We describe processes and materials for use with LENR, CANR, or cold fusion devices, or devices specifically designed for the LANP process. LENR, CANR, and cold fusion devices are thought to be low energy devices that operate at less than the boiling temperature of water. The LANP device achieves reactions at stellar temperatures.

Devices of either type consist of a vessel containing a medium (for example water or heavy water), an anode, a cathode, and an electrical source that activates an electrolysis process within the vessel. The cathode can take any of the forms described in the referenced patents, or others that are not yet invented. The cathode may be sophisticated in terms of its layered composition and shape, but must have as its active component a metal that forms hydrides, or other similarly acting material, possibly organic, that acts to absorb hydrogen nuclei or deuterons and convert their kinetic energy to stored radiation energy. Several such devices that use metal hydrides are described in the referenced patent searches. The rest of the discussion in this application will focus on metal hydrides as a good prototype for understanding LANP

The electrolytic cell housing consists of a non-conductive housing, and can have inlet and outlet ports so that flow through operation can be achieved. Conductive grids are interconnected within the housing.

The electrolysis vessel is (energy) loaded by running it for several weeks, or even months, all the time renewing the water or heavy water that is lost. Following this loading period, the nuclear process ignites fusion and fission reactions, and excess heat production/loss begins, lasting sometimes for weeks. Devices of this type are described in the US patents referenced in this application.

The Least Action Nuclear Process, LANP process is not difficult to understand. The process begins with the uptake of deuterium or hydrogen by a host lattice, generally metal, and most commonly palladium, platinum, or nickel, and less commonly uranium, lanthanum, praseodymium, cerium, titanium, zirconium, vanadium, tantalum, hafnium and thorium. The product of this uptake process is called a metal hydride. There is ample theory and experimental observation of metal hydrides (7) to establish that palladium, platinum, nickel and several other transition and rare earth metals possess the ability to uptake and store deuterium or hydrogen. These three are the most widely used in LENR experiments today. The process that underlies the uptake is known to be a reversible one, but its mechanisms are largely unknown. It is presumed that the captured deuterium or hydrogen nuclei migrate into the metal lattice, and occupy spaces between the face centered cubic host metal atoms. The hydrogen can be removed by heating the metal hydride.

The theoretical foundations lie in the reversible uptake of deuterons or hydrogen nuclei which are initially in random, temperature dependent motion near the surface of a metal cathode. The energy possessed by an individual nuclei is its kinetic energy given by E=m·v²/2 where m is the nuclei mass, and v is the temperature dependent, average velocity of the nucleus in the electrolysis chamber. The nucleus' motion ceases at the instant of uptake (1), and we say that it has been ‘quieted’. This energy is conserved in the uptake process in accordance with the First Law of Thermodynamics, and becomes a part of the metal lattices total energy. In this way, heat of random motion is harvested by the metal lattice and stored until the moment of nuclear ignition. The higher the temperature of the electrolysis reactor, the more quickly the ignition temperature is achieved.

The first step in LANP is loading the electrode according to the theory discussed in the previous step. An electrical current is applied across the electrolysis devise. The device is loaded by running it for several weeks or even months, all the time renewing the water or heavy water that is lost. As the electrode is loaded, there occurs a separation between the thermodynamic temperature of the device, and the internal radiation temperature of the metal lattice in the cathode. The thermodynamic temperature remains essentially constant at about Tₘ=60° C., while the radiation temperature increases in quantum amounts (equal to the harvested thermal motion of each deuteron), always storing the energy increase in a thermodynamically reversible way first as excited electronic states, then as excited nuclear states. The excited nuclear state energy storage is what eventually participates in the processes' nuclear reactions. It is stored as resonant exchange of gamma intensity, electromagnetic energy between two identical nuclei in accordance with the Mossbauer effects. This is a reversible process wherein no energy is lost to waste heat, and the exchange continues, unchanged, until the moment that it is needed to ignite the LANP process. I describe this kind of reversible energy exchange for the case of a covalent bond in Szumski (6), and for the case of an LANP device in Szumski (1). The first step of a two step absorption and emission process occurs adiabatically, without recourse to irreversibility, and energy loss to heat of motion.

Once T_{R} reaches the LANP ignition temperature, around 10⁷° K., nuclear reactions commence. In the case where exothermal processes predominate, excess heat is evolved. If on the other hand, endothermic nuclear processes predominate no excess heat production occurs.

Although within the context of the reversible reaction, any reaction that can occur is a candidate for what will happen next, it is the Principle of Least Action that selects one reaction among all of the candidates. The LANP process uses simple arithmetic calculations to simulate the Principle of Least Action's selection process. This is actually a least energy calculation. One first calculates the mass of the nuclear reactants in atomic mass units (amu). Then one calculates the mass of the stable, final reaction products. The difference between these, Δm=m_{reac tan ts}|m_{products}, is the mass change resulting from the reaction, and E=Δmc² can be used to calculate the energy consumed(−) or produced(+) by the overall nuclear process. In practice, it is entirely proper to merely use the mass change, Δm as the energy change for determining which reaction actually occurs.

Consider the reaction where:

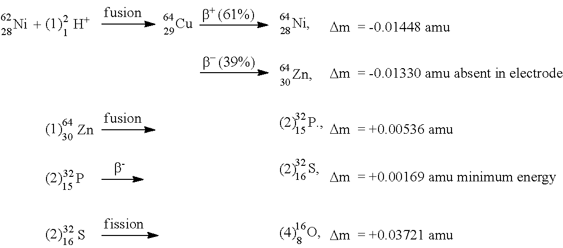

In words: nickel-62 fusion reacts with 1 deuteron to create copper-64 which in turn decays along two pathways. 61% of the copper-64 decays to nickel-64. 39% decays to zinc-64. The changes in atomic mass units is shown in the right hand column (for example the atomic mass of nickel-62 (61.928345 amu) plus the atomic mass of a deuteron (2.014101 amu) is (63.942446 amu), minus the atomic mass of the final stable product nickel-64 (63.927966 amu) yielding a mass change of 0.01448 amu. We also note that zinc-64 has a smaller mass change, but is absent from the isotope inventory in Miley's post-experiment electrode. When this happens, we look to see what other lower energy change reactions are occurring. We find that zinc-64 undergoing fission to two phosphorus-32's yields a lower mass change of 0.00536 amu and that this unstable product decays by beta-minus decay to sulpher-32 which is one of the stable isotopes found in Miley's post-experiment electrode, and also the minimum energy condition for this reaction. This example is a little complicated, but illustrates the technical steps in the method that is required to select final isotopes in accordance with the Principle of Least Action. The tables attached to Szumski (1) provide this same information for 210 nuclear reactions occurring in Miley's nickel electrode. These tables are reproduced below.

TABLE 1
Deuterium-Nickel Fusion Reactions in Miley's Nickel Coated Micro-spheres

| | Initial | | Energy Change |
|---|---|---|---|
| Nuclear Reaction | Isotope | Stable Isotope | (amu) |
| 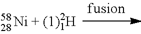 | ₂₉⁶⁰Cu | ₂₈⁶⁰Ni | −0.018658 |
| 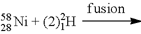 | ₃₀⁶²Zn | ₂₈⁶²Ni | −0.035201 |
| 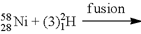 | ₃₁⁶⁴Ga | ₃₀⁶⁴Zn | −0.048506 |
| 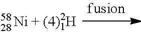 | ₃₂⁶⁶Ge | ₃₀⁶⁶Zn | −0.065716 |
| 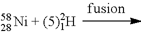 | ₃₃⁶⁸As | ₃₀⁶⁸Zn | −0.081007 |
| 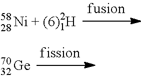 | ₃₄⁷⁰Se | 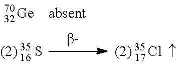 | −0.095706 −0.082248 |
| 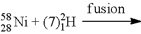 | ₃₅⁷²Br ↑^{79 sec} | ₃₂⁷²Ge | −0.111979 |
| 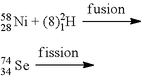 | ₃₆⁷⁴Kr ↑^{11 min} | ₃₄⁷⁴Se absent (2)₁₇³⁷Cl ↑ | −0.125678 −0.116351 |
| 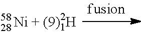 | ₃₇⁷⁶Rb | ₃₄⁷⁶Se ₃₂⁷²Ge | −0.143044 −4.140182 |
| 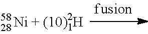 | ₃₈⁷⁸Sr | ₃₆⁷⁸Kr ↑ | −0.155995 |
| 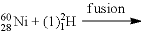 | ₂₉⁶²Cu | ₂₈⁶²Ni | −0.016543 |
| 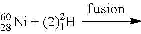 | ₃₀⁶⁴Zn | ₃₀⁶⁴Zn | −0.029847 |
| 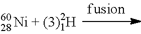 | ₃₁⁶⁶Ga | ₃₀⁶⁶Zn | −0.047058 |
| 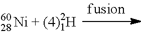 | ₃₂⁶⁸Ge | ₃₀⁶⁸Zn | −0.062349 |
| 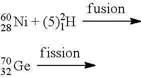 | ₃₃⁷⁰As | 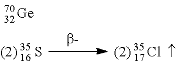 | −0.377049 −0.063579 |
| 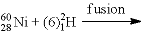 | ₃₄⁷²Se | ₃₂⁷²Ge | |
| 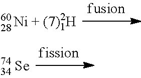 | ₃₅⁷⁴Br ↑^{25 min} | ₃₄⁷⁴Se absent (2)₁₇³⁷Cl ↑ | −0.107011 −0.097682 |
| 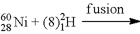 | ₃₆⁷⁶Kr ↑^{76 hr} | ₃₄⁷⁶Se | −0.124386 |
| 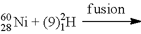 | ₃₇⁷⁸Rb | ₃₆⁷⁸Kr ↑ | −0.137337 |
| 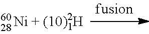 | ₃₈⁸⁰Sr | ₃₆⁸⁰Kr ↑ | −0.155425 |
| 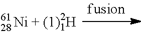 | ₂₉⁶³Cu | ₂₉⁶³Cu | −0.015560 |
| 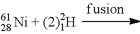 | ₃₀⁶⁵Zn | ₂₉⁶⁵Cu | −0.031470 |
| 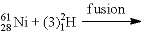 | ₃₁⁶⁷Ga | ₃₀⁶⁷Zn | −0.046234 |
| 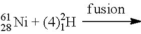 | ₃₂⁶⁹Ge | ₃₁⁶⁹Ga | −0.061889 |
| 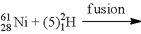 | ₃₃⁷¹As | ₃₃⁷¹Ga | −0.076863 |
| 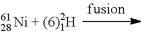 | ₃₄⁷³Se | ₃₂⁷³Ge | −0.092207 |
| 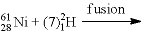 | ₃₅⁷⁵Br ↑^{96 min} | ₃₃⁷⁵As | −0.108171 |
| 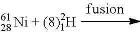 | ₃₆⁷⁷Kr ↑^{74 min} | ₃₃⁷⁷Se | −0.123956 |
| 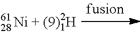 | ₃₇⁷⁹Rb | ₃₅⁷⁹Br ↑ | −0.139634 |
| 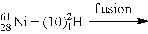 | ₃₂⁸¹Sr | ₃₅⁸¹Br ↑ | −0.155783 |
| 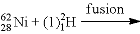 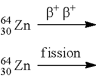 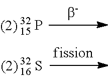 | ₂₉⁶⁴Cu (2)₁₅³²P | ₂₈⁶⁴Ni ₃₀⁶⁴Zn absent(note 1) ₂₈⁶⁴Ni (2)₁₆³²S (4)₈¹⁶O Example | −0.014480 −0.013304 −0.014480 +0.005368 +0.001696 +0.037212 |
| 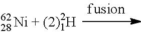 | ₃₀⁶⁶Zn | ₃₀⁶⁶Zn | −0.030515 |
| 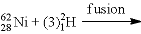 | ₃₁⁶⁸Ge | ₃₀⁶⁸Zn | −0.045806 |
| 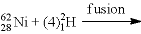 | 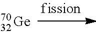 | ₁₇³⁵Cl ↑ | −0.047048 |
| 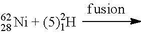 | ₃₃⁷²As | ₃₁⁷²Ge | −0.076778 |
| 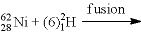 | 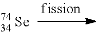 | ₁₇³⁷Cl ↑ | −0.081150 |
| 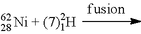 | ₃₅⁷⁶Br ↑^{16 hrs} | ₃₄⁷⁶Se | −0.107843 |
| 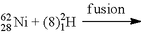 | ₃₆⁷⁸Kr ↑ | ₃₆⁷⁸Kr ↑ | −0.120794 |
| 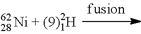 | ₃₇⁸⁰Rb | ₃₆⁸⁰Kr ↑ | −0.138882 |
| 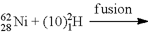 | ₃₈⁸⁴Sr | ₃₆⁸²Kr | −0.155879 |
| 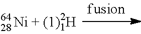 | ₂₉⁶⁶Cu | ₃₀⁶⁶Zn | −0.016034 |
| 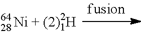 | ₃₀⁶⁸Zn | ₃₀⁶⁸Zn | −0.031325 |
| 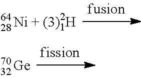 | ₃₁⁷⁰Ga | 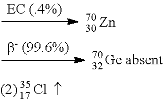 | −0.044952 −0.046022 −0.032565 |
| 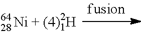 | ₃₂⁷²Ge | | −0.062297 |
| 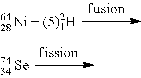 | 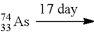 | 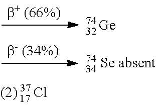 | −0.077293 −0.075994 −0.066666 |
| 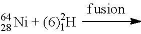 | ₃₄⁷⁶Se | | −0.093363 |
| 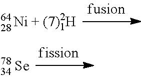 | ₃₅⁷⁸Br ↑^{6 min} | 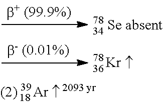 | −0.109369 −0.106313 +0.090805 |
| 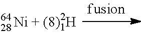 | ₃₆⁸⁰Kr ↑^{stable} | ₃₆⁸⁰Kr ↑ | −0.124401 |
| 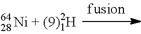 | ₃ [symbol] ⁸⁰Rb | ₃₆⁸²Kr ↑ | −0.141398 |
| 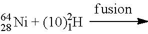 | ₃₈⁸ [symbol] Sr | ₃₆⁸⁴Kr ↑ | −0.157476 |

Table Notes from (‘Isotopes of (element)’, Wikipedia, Apr. 13, 2012)
Note 1 - Believed to undergo β⁺ β⁺ decay to ₂₈⁶⁴Ni with half-life of over 2.3 × 10¹⁸ years
Note 2 - Theoretically capable of spontaneous fission
Note 3 - End product of stellar nucleosynthesis
Note 4 - Believed to β⁺ decay to ₅₁¹²³Sb with a half-life of over 600 × 10¹² years.
Note 5 - Suspected of β⁺ β⁺ decay to ₂₂⁵⁰Ti with a half life of no less than 1.3 × 10¹⁸ years.
Note 6 - Highest binding energy per nucleon of all nuclides [symbol]
indicates data missing or illegible when filed

TABLE 2
Deuterium Fusion Reactions with Cu Impurities in
Miley's Nickel Coated Micro-spheres

| | | | Energy Change |
|---|---|---|---|
| Nuclear Reacton | Initial Isotope | Stable Isotope | (amu) |
| 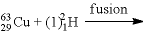 | ₃₀⁶⁵Zn | ₂₉⁶⁵Cu | −0.015909 |
| 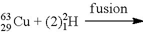 | ₃₁⁶⁷Ga | ₃₀⁶⁷Zn | −0.030673 |
| 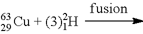 | ₃₂⁶⁹Ge | ₃₁⁶⁹Ga | −0.046328 |
| 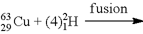 | ₃₃⁷¹As | ₃₁⁷¹Ga | −0.061302 |
| 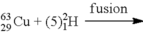 | ₃₄⁷³Se | ₃₂⁷³Ge | −0.076646 |
| 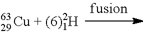 | ₃₅⁷⁵Br ↑^{96 min} | ₃₃⁷⁵As | −0.092610 |
| 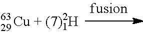 | ₃₆⁷⁷Kr ↑^{74 min} | ₃₄⁷⁷Se | −0.108394 |
| 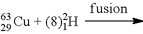 | ₃₇⁷⁹Rb | ₃₅⁷⁹Br ↑ | −0.124072 |
| 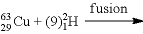 | ₃₈⁸¹Sr | ₃₅⁸¹Br ↑ | −0.140220 |
| 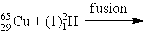 | ₃₀⁶⁷Zn | ₃₀⁶⁷Zn | −0.014763 |
| 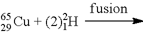 | ₃₁⁶⁹Ga | ₃₁⁶⁹Ga | −0.030418 |
| 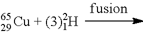 | ₃₂⁷¹Ge | ₃₁⁷¹Ga | −0.045392 |
| 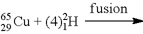 | ₃₃⁷³As | ₃₂⁷³Ge | −0.060736 |
| 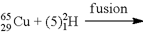 | ₃₄⁷⁵Se | ₃₃⁷⁵As | −0.076700 |
| 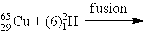 | ₃₅⁷⁷Br ↑^{57 hrs} | ₃₄⁷⁷Se | −0.092484 |
| 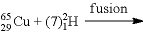 | ₃₆⁷⁹Kr ↑^{35 hrs} | ₃₅⁷⁹Br ↑ | −0.108163 |

TABLE 3
Deuterium Fusion Reactions with Zn Impurities in Miley's Nickel Coated Micro-spheres

| | | | Energy Change |
|---|---|---|---|
| Nuclear Reacton | Initial Isotope | Stable Isotope | (amu) |
| 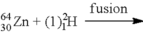 | ₃₁⁶⁶Ga | ₃₀⁶⁶Zn | −0.017210 |
| 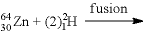 | ₃₂⁶⁸Ge | ₃₀⁶⁸Zn | −0.032501 |
| 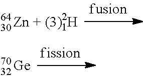 | ₃₃⁷⁰As | ₃₂⁷⁰Ge absent (2)₁₇³⁵Cl ↑ | −0.047200 −0.033743 |
| 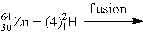 | ₃₄⁷²Se | ₃₂⁷²Ge | −0.063472 |
| 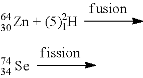 | ₃₅⁷⁴Br ↑^{25 min} | ₃₄⁷⁴Se absent (2)₁₇³⁷Cl ↑ | −0.077174 −0.067825 |
| 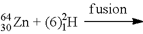 | ₃₆⁷⁶Kr ↑^{14.8 hrs} | ₃₄⁷⁶Se | −0.094537 |
| 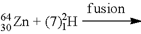 | ₃₇⁷⁸Rb | ₃₆⁷⁸Kr ↑ | −0.107488 |
| 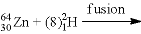 | ₃₈⁸⁰Sr | ₃₆⁸⁰Kr ↑ | −0.125575 |
| 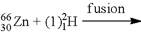 | ₃₁⁶⁸Zn | ₃₁⁶⁸Zn | −0.015290 |
| 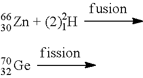 | ₃₂⁷⁰Ge absent | (2)₁₇³⁵Cl ↑ | −0.029969 −0.016531 |
| 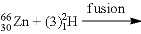 | ₃₃⁷²As | ₃₂⁷²Ge | −0.046262 |
| 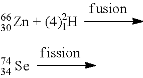 | ₃₄⁷⁴Se | (2)₁₇³⁷Cl | −0.059963 −0.050634 |
| 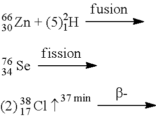 | ₃₅⁷⁶Br ↑^{16 hrs} | ₃₄⁷⁶Se (2)₁₇³⁸Cl ↑^{37 min} (2)₁₇⁴⁰Ar ↑ | −0.077328 −0.060521 −0.071077 |
| 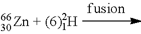 | ₃₆⁷⁸Kr ↑ | ₃₆⁷⁸Kr ↑ | −0.090277 |
| 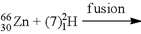 | ₃₇⁸⁰Rb | ₃₆⁸⁰Kr ↑ | −0.108365 |
| 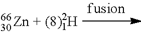 | ₃₈⁸²Sr | ₃₆⁸²Kr ↑ | −0.125362 |
| 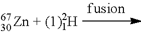 | ₃₁⁶⁹Ga | ₃₁⁶⁹Ga | −0.015655 |
| 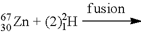 | ₃₂⁷¹Ge | ₃₁⁷¹Ga | −0.030629 |
| 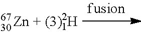 | ₃₃⁷³As | ₃₂⁷³Ge | −0.045973 |
| 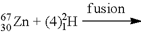 | ₃₄⁷⁵Se | ₃₃⁷⁵As | −0.061636 |
| 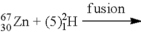 | ₃₅⁷⁷Br ↑^{57 hrs} | ₃₄⁷⁷Se | −0.077721 |
| 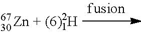 | ₃₆⁷⁹Kr ↑^{35 hrs} | ₃₅⁷⁹Br ↑ | −0.093399 |
| 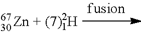 | ₃₇⁸¹Rb | ₃₆⁸¹Kr ↑ | −0.109246 |
| 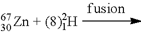 | ₃₈⁸³Sr | ₃₆⁸³Kr ↑ | −0.125803 |
| 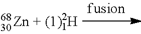 | ₃₁⁷⁰Ga | ₃₀⁷⁰Zn | −0.013626 |
| 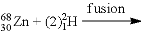 | ₃₂⁷²Ge | ₃₂⁷²Ge | −0.030971 |
| 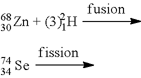 | ₃₃⁷⁴As | 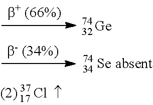 | −0.045971 −0.044672 −0.035344 |
| 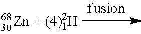 | ₃₄⁷⁶Se | | −0.062036 |
| 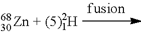 | ₃₅⁷⁸Br ↑^{6 min} | 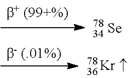 | −0.078043 −0.074988 |
| 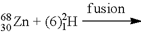 | ₃₆⁸⁰Kr ↑ | ₃₆⁸⁰Kr ↑ | −0.093074 |
| 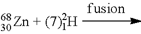 | ₃₇⁸²Kr ↑ | ₃₇⁸²Kr ↑ | −0.110071 |
| 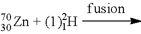 | ₃₁⁷²Ga | ₃₂⁷²Ge | −0.017345 |
| 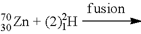 | ₃₂⁷⁴Ge | ₃₂⁷⁴Ge | −0.032344 |
| 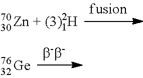 | ₃₃⁷⁶As | 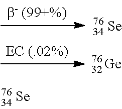 | −0.048411 −0.046222 −0.048411 |
| 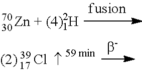 | 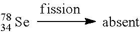 | (2)₁₇³⁹Cl ↑^{59 min} (2)₁₈³⁹Ar ↑^{269 yr} | −0.064417 −0.045710 −0.053099 |
| 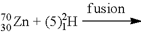 | ₃₅⁸⁰Br ↑^{18 min} | 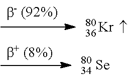 | −0.079449 −0.079306 |
| 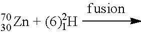 | ₃₆⁸²Kr ↑ | | −0.096444 |
| 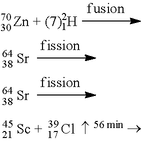 | ₃₇⁸⁴Rb | 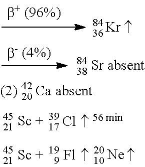 | −0.112524 −0.110606 −0.106795 −0.100111 −0.577276 |

TABLE 4
Deuterium Fusion Reactions with Ag and Co Impurities in Miley's Nickel Coated Micro-spheres

| | | | Energy Change |
|---|---|---|---|
| Nuclear Reaction | Initial Isotope | Stable Isotope | (amu) |
| 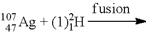 | ₄₈¹⁰⁷Cd | ₄₇¹⁰⁹Ag | −0.014446 |
| 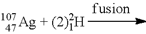 | ₄₉¹¹¹In | ₄₈¹¹¹Cd | −0.029122 |
| 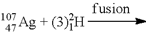 | ₅₀¹¹³Sn | ₄₉¹¹³In | −0.043344 |
| 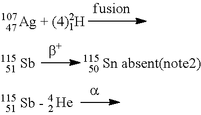 | ₅₁¹¹⁵Sb | ₄₉¹¹¹Cd + ₂⁴He | −0.0581621 −0.0547227 |
| 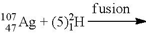 | ₅₂¹¹⁷Te | ₅₀¹¹⁷Sn | −0.0726538 |
| 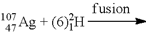 | ₅₃¹¹⁹I ↑^{19 min} | ₅₀¹¹⁹Sn | −0.0863996 |
| 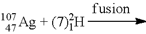 | ₅₄¹²¹Xe ↑^{40 min} | ₅₁¹²¹Sb | −0.0999937 |
| 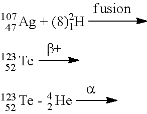 | ₅₅¹²³Cs | ₅₂¹²³Te absent(note 4) ₅₁¹²³Sb absent ₅₀¹¹⁹Sn | −0.113641 −0.113697 −0.111999 |
| 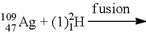 | ₄₈¹¹¹Cd | | −0.014675 |
| 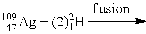 | ₄₉¹¹³In | | −0.028897 |
| 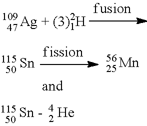 | ₅₀¹¹⁵Sn note2 | ₂₆⁵⁶Fe ₂₇⁵⁹Co ₄₈¹¹¹Cd | 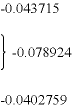 |
| 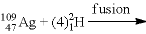 | ₅₁¹¹⁷Sb | ₅₀¹¹⁷Sn | −0.0582071 |
| 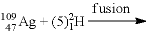 | ₅₂¹¹⁹Te | ₅₀¹¹⁹Sn | −0.0719528 |
| 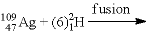 | ₅₃¹²¹I ↑^{2 hrs} | ₅₁¹²¹Sb | −0.0855469 |
| 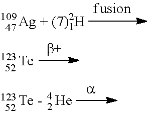 | ₅₄¹²³Xe ↑^{2.1 hr} | ₅₂¹²³Te absent(note 4) ₅₁¹²³Sb absent ₅₀¹¹⁹Sn | −0.0991943 −0.0992503 −0.0975531 |
| 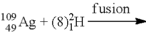 | ₅₅¹²⁵Cs | ₅₂¹²⁵Te | −0.113135 |
| 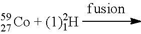 | ₂₈⁶¹Ni | | −0.0162407 |
| 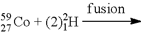 | ₂₉⁶³Cu | | −0.0318010 |
| 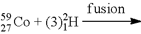 | ₃₀⁶⁵Zn | ₂₉⁶⁵Cu | −0.0377108 |
| 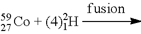 | ₃₁⁶⁷Ga | ₃₀⁶⁷Zn | −0.0624748 |
| 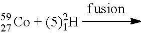 | ₃₂⁶⁹Ge | ₃₁⁶⁹Ga | −0.0781302 |
| 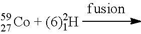 | ₃₃⁷¹As | ₃₁⁷¹Ga | −0.0931043 |
| 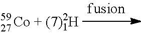 | ₃₄⁷³As | ₃₂⁷³Ge | −0.1084485 |
| 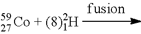 | ₃₅⁷⁵Br ↑^{96 min} | ₃₃⁷⁵As | −0.1244127 |
| 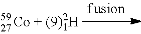 | ₃₆⁷⁷Kr ↑^{4 min} | 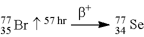 | −0.1401969 |

TABLE 5
Ag and Ni Fission Reactions in Miley's Nickel Coated Micro-spheres

| | | | Energy |
|---|---|---|---|
| Nuclear Reactions | Initial Isotope | Stable Isotope | Change (amu) |
| 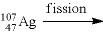 | ₂₃⁵¹V ₂₄⁵⁶Cr | ₂₆⁵⁶Fe | 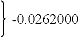 |
| 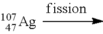 | ₂₃⁵²V ₂₄⁵⁵Cr | ₂₄⁵²Cr ₂₅⁵⁵Mn | 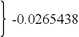 |
| 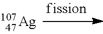 | ₂₃⁵³V ₂₄⁵⁴Cr | ₂₄⁵³Cr | 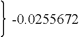 |
| 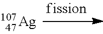 | ₂₃⁵⁴V ₂₄⁵³Cr | ₂₄⁵⁴Cr | 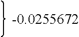 |
| 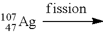 | ₂₃⁵⁵V ₂₄⁵²Cr | ₂₅⁵⁵Mn | 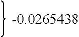 |
| 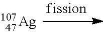 | ₂₂⁵¹Ti ₂₅⁵⁶Mn | ₂₃⁵¹V ₂₆⁵⁶Fe | 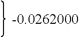 |
| 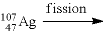 | ₂₂⁵²Ti ₂₅⁵⁵Mn | ₂₄⁵²Cr | 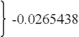 |
| 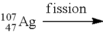 | ₂₂⁵³Ti ₂₅⁵⁴Mn | 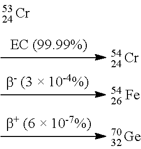 | −0.0255672 −0.0248371* −0.0255672 |
| 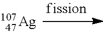 | ₂₂⁵⁴Ti ₂₅⁵³Mn | ₂₄⁵⁴Cr ₂₄⁵³Cr | 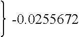 |
| 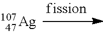 | ₂₂⁵⁵Ti ₂₅⁵²Mn | ₂₅⁵⁵Mn ₂₄⁵²Cr | 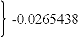 |
| 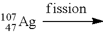 | ₂₁⁴⁵Sc ₂₆⁶²Fe | ₂₈⁶²Ni | 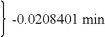 |
| 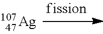 | ₂₀⁵⁰Ca ₂₇⁵⁹Co | ₂₂⁵⁰Ti | 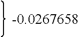 |
| 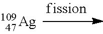 | ₂₂⁵³Ti ₂₂⁵⁶Mn | ₂₄⁵³Cr ₂₆⁵⁶Fe | 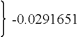 |
| 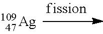 | ₂₂⁵⁴Ti ₂₅⁵⁵Mn | ₂₄⁵⁴Cr | 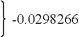 |
| 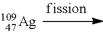 | ₂₂⁵⁵Ti ₂₅⁵⁴Mn | 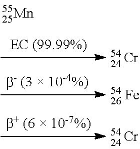 | +0.02782582 +0.0270965* +0.02782582 |
| 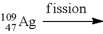 | ₂₂⁵⁶Ti ₂₅⁵³Mn | ₂₆⁵⁶Fe ₂₄⁵³Cr | 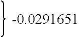 |
| 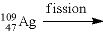 | ₂₃⁵³V ₂₄⁵⁶Cr | ₂₄⁵³Cr ₂₆⁵⁶Fe | 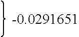 |
| 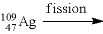 | ₂₃⁵⁵V ₂₄⁵⁴Cr | ₂₅⁵⁵Mn | 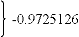 |
| 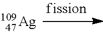 | ₂₃⁵⁶V ₂₄⁵³Cr | ₂₆⁵⁶Fe | 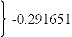 |
| . . . | | | |
| 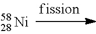 | (2)₁₄²⁹Si | | +0.0176465 |
| 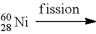 | (2)₁₄³⁰Si | | +0.0167539 |
| 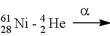 | ₂₆⁵⁷Fe | | +0.0069412 |
| 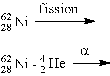 | (2)₁₄³¹Si | (2)₁₅³¹P absent ₂₆⁵⁸Fe absent | +0.0191782 +0.0075337 |
| 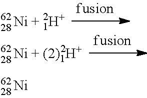 | | ₂₈⁶⁴Ni absent ₃₀⁶⁶Zn absent ₂₈⁶²Ni (note 6) | −0.01448087 −0.3051524 0.0000000 |
| 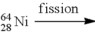 | (2)₁₄³²Si | (2)₁₆³²S | +0.016176 |

TABLE 6
Ni Alpha Decay in Miley's Nickle Coated Micro-spheres

| | | | Energy |
|---|---|---|---|
| | | Stable | Change |
| Nuclear Reaction | Initial Isotope | Isotope | (amu) |
| 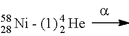 | ₂₆⁵⁴Fe | ₂₆⁵⁴Fe | +0.006870 |
| 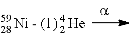 | ₂₆⁵⁵Fe | ₂₅⁵⁵Mn | +0.0063016 |
| 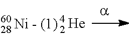 | ₂₆⁵⁶Fe | ₂₆⁵⁶Fe | +0.0067543 |
| 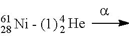 | ₂₆⁵⁷Fe | ₂₆⁵⁷Fe | +0.0069412 |
| 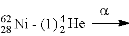 | 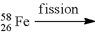 | (2)₁₄²⁹Si | +0.0272476 |
| 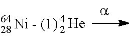 | ₂₆⁵⁰Fe | ₂₆⁶⁰Ni | +0.0054234 |
| 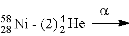 | 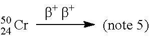 | ₂₂⁵⁰Ti | +0.014654 |
| 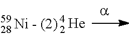 | ₂₄⁵¹Cr | ₂₃⁵¹V | +0.0148193 |
| 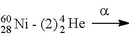 | ₂₄⁵²Cr | | +0.0149276 |
| 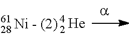 | ₂₄⁵³Cr | | +0.0147999 |
| 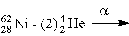 | ₂₄⁵⁴Cr | | +0.1574181 |
| 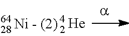 | ₂₄⁵⁶Cr | ₂₆⁵⁶Fe | +0.0121778 |
| 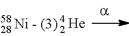 | ₂₂⁴⁶Ti | ₂₂⁴⁶Ti | +0.0250984 |
| 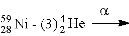 | ₂₂⁴⁷Ti | ₂₂⁴⁷Ti | +0.0252261 |
| 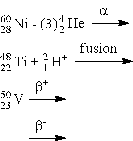 | ₂₂⁴⁸Ti absent | ₂₃⁵⁰V ₂₂⁵⁰Ti ₂₄⁵⁰Cr | +0.024969 −0.014889 −0.0172568 −0.0160038 |
| 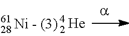 | ₂₂⁴⁹Ti | ₂₂⁴⁹Ti | +0.0246237 |
| 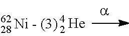 | ₂₂⁵⁰Ti | | +0.0242558 |
| 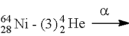 | ₂₂⁵²Ti | ₂₄⁵²Cr | +0.0203510 |

TABLE 7
₄₇¹⁰⁷Ag Alpha Decay in Miley's Nickle Coated Micro-spheres

| | | | Energy |
|---|---|---|---|
| | | | Change |
| Nuclear Reaction | Initial Isotope | Stable Isotope | (amu) |
| 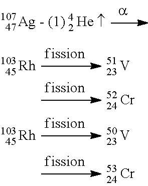 | ₄₅¹⁰³Rh (stable) | ₄₅¹⁰³Rh absent(note2) ₂₃⁵¹V ₂₄⁵²Cr ₂₃⁵⁰V ₂₄⁵³Cr | 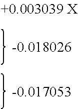 |
| 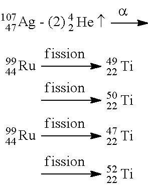 | ₄₃⁹⁹Tc | ₄₄⁹⁹Rh absent(note2) ₂₂⁴⁹Ti ₂₂⁵⁰Ti ₂₂⁴⁷Ti ₂₂⁵²Ti | 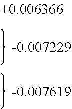 |
| 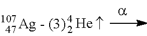 | ₄₁⁹⁵Nb | ₄₂⁹⁵Mo | +0.008554 |
| 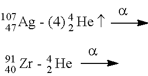 | ₃₉⁹¹Y | ₄₀⁹¹Zr absent ₃₈⁸⁷Sr | +0.010961 +0.005834 |
| 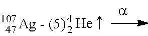 | ₃₇⁸⁷Ru | ₃₈⁸⁷Sr | +0.008554 |
| 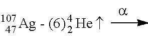 | ₃₅⁸³Br ⇑^{2.9 min} | ₃₇⁸⁵Rb | +0.025632 |
| 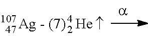 | ₃₃⁷⁹As | ₃₅⁷⁹Br ⇑ | +0.029649 |
| 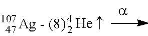 | ₂₉⁷¹Cu | ₃₃⁷⁵As | +0.037325 |

TABLE 8
₄₇¹⁰⁹Ag Alpha Decay in Miley's Nickle Coated Micro-spheres

| | Initial | | Energy |
|---|---|---|---|
| Nuclear Reaction | Isotope | Stable Isotope | Change (amu) |
| 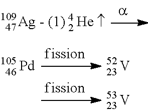 | ₄₅¹⁰⁵Rh | ₄₆¹⁰⁵Pd (note 2) ₂₄⁵²Cr ₂₄⁵³Cr | +0.002936 −1.021133 +0.097915 |
| 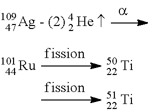 | ₄₃¹⁰¹Tc | ₄₄¹⁰¹Ru (note 2) ₂₂⁵⁰Ti ₂₃⁵¹V | +0.006036 −1.009963 +0.968373 |
| 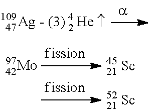 | ₄₁⁹⁷Nb | ₄₂⁹⁷Mo (note 2) ₂₁⁴⁵Sc ₂₄⁵²Cr | +0.009079 −6.985118 +6.984072 |
| 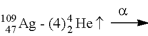 | ₃₈⁹³Y | ₄₁⁹³Nb | +0.012039 |
| 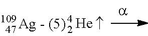 | ₃₇⁸⁹Ru | ₃₈⁸⁹Y | +0.015714 |
| 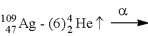 | ₃₅⁸⁵Br ⇑^{2.9 min} | ₃₇⁸⁵Rb | +0.022657 |
| 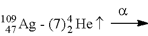 | ₃₃⁸¹As | ₃₅⁸¹Br ⇑ | +0.029761 |
| 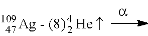 | ₃₁⁷⁵Ga | ₃₄⁷⁷Se | +0.035988 |

TABLE 9
Selected Nickel-nickel fusion reactions in Miley's Nickel Coated Micro-spheres

| | Initial | | Energy |
|---|---|---|---|
| Isotope | Isotope | Stable Isotope | Change (amu) |
| 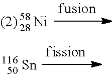 | ₅₆¹¹⁶Ba | ₄₈¹¹¹Cd, ₅₀¹¹²Sn, ₅₀¹¹⁴Sn, ₅₀¹¹⁵Sn, [₅₀¹¹⁶Sn] absent (2)₂₆⁵⁸Fe | −0.0310552 −0.0041346 |
| 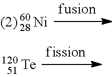 | ₅₆¹²⁰Ba | ₅₀¹¹⁶Sn, ₅₀¹¹⁸Sn, [₅₁¹²⁰Te] absent (2)₂₈⁶⁰Ni | +0.0424482 −0.0000000 |
| 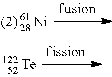 | ₅₆¹²²Ba | ₅₀¹¹⁸Sn, {₅₂¹²²Te} absent (2)₂₈⁶¹Ni | −0.0409319 −0.0000000 |
| 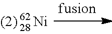 | ₅₆¹²⁴Ba | [₅₄¹²⁴Xe] | +0.0492028 |
| 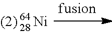 | ₅₆¹²⁸Ba | [₅₄¹²⁸Xe] | +0.0475993 |
| 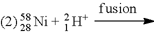 | ₅₇¹¹⁸La | ₅₀¹¹⁴Sn, ₅₀¹¹⁶Sn, ₅₀¹¹⁷Sn, [₅₀¹¹⁸Sn] | +0.0478416 |
| 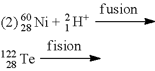 | ₅₇¹²²La | ₅₀¹¹⁸Sn, ₅₁¹²¹Sb, [₅₂¹²²Te] absent (note 3) (2)₂₈⁶¹Ni | +0.027369 +0.013562 |
| . . . | | | |
| 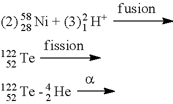 | ₅₉¹²²Pr | ₅₀¹¹⁸Sn, ₅₂¹²⁰Te, ₅₁¹²¹Sb, [₅₂¹²²Te] absent (2)₂₈⁶¹Ni ₅₀¹¹⁸Sn + He | −0.0095521 −0.050879 +0.014644 |
| 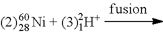 | ₅₉¹²⁶Pr | ₅₂¹²⁵Te, [₅₄¹²⁶Xe ⇑] | 0.0003958 |
| . . . | | | |
| 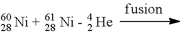 | ₅₄¹¹⁷Xe | ₅₀¹¹⁶Sn, [₅₀¹¹⁷Sn] | +0.0437128 |
| 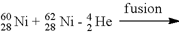 | ₅₄¹¹⁸Xe | [₅₀¹¹⁸Sn] | +0.0490007 |
| 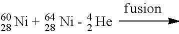 | ₅₄¹²⁰Xe | [₅₂¹²⁰Te] | +0.0478708 |
| 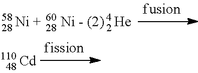 | ₅₂¹¹⁰Te | ₄₇¹⁰⁹Ag, [₄₈¹¹⁰Cd] absent [(2)₂₄⁵⁵Mn] | +0.042079 +0.015167 |
| 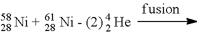 | ₅₂¹¹¹Te | ₄₈¹¹⁰Cd, [₄₈¹¹¹Cd] | +0.042985 |
| 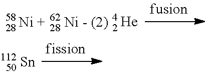 | ₅₂¹¹²Te | [₅₀¹¹²Sn] [(2)₂₆⁵⁶Fe] | +0.046336 +0.019328 |
| 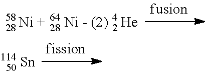 | ₅₂¹¹⁴Te | [₅₀¹¹⁴Sn] [(2)₂₆⁵⁷Fe] | +0.044676 +0.012685 |

TABLE 10
Selected reactions for Nickel Fusion with Electrode Impurities in Miley's Nickel Coated Micro-Spheres

| | Initial | | Energy Change |
|---|---|---|---|
| Reaction | Isotope | Stable Isotopes | (amu) |
| 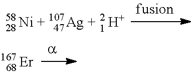 | ₇₆¹⁶⁷Os | ₆₀¹⁴³Nd, ₆₂¹⁴⁷Sm, ₆₄¹⁵⁵Gd, ₆₅¹⁵⁹Tb, ₆₆¹⁶³Dy, [₆₈¹⁶⁷Er] absent [₆₆¹⁶³Dy] + ₂⁴He* | +0.0775065 +0.0767937 |
| 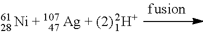 | ₇₇¹⁷²Ir | ₆₈¹⁶⁴Er, ₇₀¹⁶⁸Yb, [₇₀¹⁷²Yb] | +0.0720249 |
| 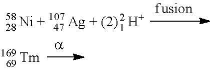 | ₇₇¹⁶⁹Ir | ₅₉¹⁴¹Pr, ₆₀¹⁴⁵Nd, ₆₂¹⁴⁹Sm, ₆₃¹⁵³Eu, ₆₄¹⁵⁷Gd, ₆₆¹⁶¹Dy, ₆₇¹⁶⁵Ho, [₆₉¹⁶⁹Tm] absent ₆₇¹⁶⁵Ho + ₂⁴He* | +0.0655698 +0.0642818 |
| 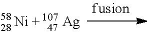 | ₇₅¹⁶⁵Re | ₅₉¹⁴¹Pr, ₆₀¹⁴⁵Nd, ₆₂¹⁴⁹Sm, ₆₃¹⁵³Eu, ₆₄¹⁵⁷Gd, ₆₆¹⁶¹Dy, [₆₇¹⁶⁵Ho] | +0.089882 |
| 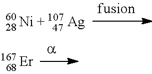 | ₇₅¹⁶⁷Re | ₆₀¹⁴³Nd, ₆₂¹⁴⁷Sm, ₆₃¹⁵¹Eu, ₆₄¹⁵⁵Gd, ₆₅¹⁵⁹Tb, [₆₈¹⁶⁷Er] absent, ₆₉¹⁶⁹Tm [₆₆¹⁶³Dy] + ₂⁴He* | +0.096215 +0.0954532 |
| 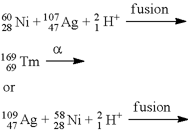 | ₇₆¹⁶⁹Os ₇₆¹⁶⁹Os | ₅₉¹⁴¹Pr, ₆₀¹⁴⁵Nd, ₆₂¹⁴⁹Sm, ₆₃¹⁵³Eu, ₆₄¹⁵⁷Gd, ₆₆¹⁶¹Dy, ₆₈¹⁶⁴Er, ₆₇¹⁶⁵Ho, [₆₉¹⁶⁹Tm] absent ₆₇¹⁶⁵Ho + ₂⁴He* same as above but with a different overall mass change | +0.08422812 +0.0829402 |

*Source of helium detected in cold fusion experiments

The observation that the Principle of Least Action is operative in the selection process for observed final isotopes is very strong evidence that we are dealing with a thermodynamically reversible process . . . the fundamental premise of this invention. The observation that this invention selects observed isotopes in all 210 cases is a remarkable test of the method that is unequaled by any other proposed theory.

The LANP process can be modified in predictable ways to customize its operation for specific purposes. The calculation procedure shown above in [0056] can be used to select impurities that can be added to the cathode to produce specific reactions (exothermic or endothermic), or to produce specific isotopes preferentially, but not exclusively.

For example, the reaction of ⁶²Ni+²H⁺ shown above produces excess energy, as do all of the nuclear reactions having a positive mass change in Tables 1-10. Designing electrodes that favor excess energy, while minimizing energy consumption (negative Δm change) can be used to optimize the electrode for excess heat production.

As a second example, the selective production of specific isotopes can be achieved by doping the manufactured electrode with impurities that favor one isotope product over others. In Table 10, a reaction sequence is shown which results in dysprosium, ₆₆¹⁶³Dy. Using this reaction sequence as a template, the manufacture of cathodes made of nickel-58 with silver-107 impurities can select for the production of ₆₆¹⁶³Dy, not exclusively, but preferentially. The doping can include one or more isotopes to achieve specific LANP operational or product formation objectives.

Radioactive waste stabilization can be achieved by using an LANP device having specially manufactured electrodes containing radioactive wastes. This should produce stable isotopes of lead, and possibly other presently unknown products.

The LANP process ultimately exhausts the capacity of the electrode to produce heat or isotope product. The cathode then needs to be replaced. This can be done with a cathode made of metal coated microspheres that act as a fluid flowing through the LANP device, or some other technology that renews the cathode continuously. The used cathode is then reprocesses to recover specific products, re-purify the cathode's metal lattice material, and manufacture new cathode material.

LANP can be used as a scientific tool to study Sigma decay, or to study LANP technologies.

Further, LANP has several industrial uses. The first and most widely acclaimed is the recovery of process heat energy that can be used for other human activities. These include heat energy conversion to electricity of chemical energy, heating domestic, industrial, agricultural, or commercial spaces (or any other space), and other uses for heat energy that are either not yet apparent or not yet invented.

Second, the nuclear reaction selection process can be used to calculate the end products of a specially doped LANP electrode. For example, the first two reactions shown in Table 10 show how two rare earth metals can be produced from a nickel electrode electrolysis in heavy water. The secret lies in doping the electrode with an impurity, silver-107. The process can be made even more selective by refining the nickel so that more of it is in the nickel-58 or nickel-61 isotopic forms. This kind of predictive tool can be used to produce custom designed impurities in the final electrode. These can then be refined out of the post-LANP electrode material using known industrial separation processes.

A third application that has been proposed is using an LANP to convert radioactive wastes to stable, non-radioactive material, primarily lead-206, lead-207, lead-208.

LANP will become the fundamental process employed in domestic, industrial, commercial, and agricultural machines/devices that have already been invented or will be invented in the future.

### EXAMPLES

Some examples drawn from the very limited nuclear reactions that have been analyzed thus far will clarify these claims.

The LANP process alters the natural isotope distribution from the isotope percentages normally found on earth. This occurs because LANP uses isotopes within the electrolysis electrode to produce new isotopes. The resulting isotope distributions are known (George Miley experiments cited elsewhere in this application) to be far from those that occur naturally on planet earth. This illustrates the basic concept here. The LANP methods allow doping of the electrode materials in very specific ways that enhance beneficial outcomes including, but not limited to:
1. Heat production or reduced heat production
2. Preferential isotope production
3. Preferential isotope reduction

### Example 1

### Heat Production or Reduced Heat Production

Consider the first equation in Table 1, where amu=atomic mass units

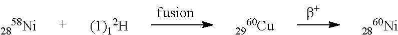

Given that the final products are 0.0181096 amu lighter than the reactants, this means that 0.0181096 amu or approximately 16.869 MeV were produced as heat energy. Table 1 also shows that the other stable isotopes of Nickel, ₂₈⁶⁰Ni, ₂₈⁶¹Ni, ₂₈_{₆₂}Ni, ₂₈⁶⁴Ni, yield smaller amounts of energy per deuteron fused. Since ₂₈⁵⁸Ni represents 68.07% of nickel isotope in naturally occurring nickel ore, this is a particularly efficient metal hydride for LANP, and these nuclear reactions.

Furthermore the heat production of a nickel electrode could be enhanced by doping the electrode material with additional ₂₈⁵⁸Ni. This might be accomplished, for example, by:

1. Adding ₂₈⁵⁸Ni to an electrode that is being designed to enhance heat production.
2. Running a LANP electrode that preferentially produced ₂₈⁵⁸Ni. This electrode might initially be used for heat production or another LANP method.

Conversely, an electrode could be designed with proportionally more ₂₈⁶⁰Ni to reduce heat production.

This example is presented to illustrate some of the design considerations involved in altering heat production from the LANP process. The combination of such doping modifications is not known at this time.

TABLE 11
Isotopes of Nickel

| | | | | | | | representative |
|---|---|---|---|---|---|---|---|
| | | | | | | | isotopic |
| nuclide | Z(p) | N(n) | isotopic mass (u) | | decay | daughter, | composition |
| symbol | excitation energy | | | half-life | mode(s)^{[6][n 1]} | isotope(s)^{[n 2]} | (mole fraction) |
| ⁵⁸Ni | 28 | 30 | 57.9353429(7) | Observationally Stable^{[n 3]} | | | 0.680769(89) |
| ⁵⁹Ni | 28 | 31 | 58.9343467(7) | 7.6(5) × 10⁴ a | EC (99%) | ⁵⁹Co | |
| | | | | | β⁺ (1.5 × 10⁻⁵%)^{[7]} | | |
| ⁶⁰Ni | 28 | 32 | 59.9307864(7) | Stable | | | 0.262231(77) |
| ⁶¹Ni | 28 | 33 | 60.9310560(7) | Stable | | | 0.011399(6) |
| ⁶²Ni^{[n 4]} | 28 | 34 | 61.9283451(6) | Stable | | | 0.036345(17) |
| ⁶³Ni | 28 | 35 | 62.9296694(6) | 100.1(20) a | β⁻ | ⁶³Cu | |

| | | |
|---|---|---|
| ^{63m}Ni | 87.15(11) keV | 1.67(3) μs |

| | | | | | |
|---|---|---|---|---|---|
| ⁶⁴Ni | 28 | 36 | 63.9279660(7) | Stable | 0.009256(9) |

### Example 2

### Enhancing the Production of Specific Isotopes

Consider the opportunity to harvest Xenon from a LANP reactor that uses nickel electrodes. The reactions in Table 9 might be useful in the design of an electrode for this purpose. The table shows three pathways to Xenon:

$${( 2 )}_{28}^{62} Ni + {\to }^{fusion} {}_{56}^{124} Ba {\to }^{{β}^{+}} {}_{55}^{124} Cs {\to }^{{β}^{+}} {}_{54}^{124} Xe \\ ( 2 ) 61.9283451 = 123.905893 \\ - 0.0492028 amu of heat consumed$$

$$123.8566902 amu ( use E = {mc}^{2} to convert to joules \}$$

$${( 2 )}_{28}^{64} Ni + {\to }^{fusion} {}_{56}^{128} Ba {\to }^{{β}^{+}} {}_{55}^{128} Cs {\to }^{{β}^{+}} {}_{54}^{128} Xe \\ ( 2 ) 63.9279660 = 127.903531 \\ - 0.0475993 amu of heat consumed$$

$$127.8559320 amu ( use E = {mc}^{2} to convert to joules \}$$

$${( 2 )}_{28}^{60} Ni + ( 2 ) {}_{1}^{2} H {\to }^{fusion} {}_{59}^{126} Pr {\to }^{{β}^{+}} {}_{55}^{126} Cs … {}_{54}^{126} Xe \\ ( 2 ) 59.930786 = 125.904274 \\ - 0.0003958 amu of heat consumed$$

$$125.9038781 amu ( use E = {mc}^{2} to convert to joules \}$$

Each of these reactions consumes heat in the LANP reactor. If a secondardy design consideration is heat production, doping the nickel electrode with ₂₈⁶²Ni or ₂₈⁶⁴Ni would consume less heat from the overall process thereby optimizing heat production as a secondardy industrial objective. However, If heat production needs to be minimized during the xenon production process, proportionally more ₂₈⁶⁰Ni might be designed into the electrode. These are again examples of how industrial objectives may govern the doping of electrode material.

### Example 3

### Enhancing the Reduction of Specific Isotopes

There can be any number of industrial reasons for wanting to reduce specific isotopes in an LANP electrode or in an LANP reactor.

Radioactive nuclei could possibly be disposed of in LANP reactors. The great virtue of the process is found in the way that it produces only stable isotope products and no radioactivity. It could be possible to dope electrodes with radioactive waste products that would then be converted to stable end products. The permissible amount of this type of doping (as a percentage by weight) is completely unknown, as are the operational variables. The limiting variable may be the percentage of radioactive waste additive in an electrode before the process leaves the realm of reversible thermodynamic processes, and ceases.

There might be cases where the evolution of gas products from the LANP reactor needs to be modified. This could be, for example, limiting the total volume of gas, or elimination of a specific type of gas such as chlorine or bromine. You will note that many of the reactions presented in the tables produce gaseous products. In these instances, it may be necessary to dope the electrode in specific ways that react away isotope fractions that will produce these gasses. This might be done as a pretreatment step in a sensitive industrial process, or for environmental health reasons.

### REFERENCES

### A. Patent Literature

There are no other applications related to this process filed by Daniel S Szumski with the United States Patent Office.

Related US PTO patents for devices that use a process similar to that described in this application include:

| | | |
|---|---|---|
| 4,943,355 | Jul. 24, 1990 | Patterson |
| 4,986,887 | Jan. 22, 1991 | Gupta, et al |
| 5,318,675 | Jun. 7, 1994 | Patterson |
| 5,372,688 | Dec. 13, 1994 | Patterson |
| 5,607,563 | | Patterson |
| 5,616,219 | Apr. 1, 1997 | Patterson |
| 5,618,394 | Apr. 8, 1997 | Patterson |
| 5,628,886 | May 13, 1997 | Patterson |
| 5,635,038 | Jun. 3, 1997 | Patterson |
| 5,672,259 | Sep. 30, 1997 | Patterson |
| 5,676,816 | Oct. 14, 1997 | Paterson |
| 6,599,404 | Jul. 29, 2003 | Miley |

### B. Non Patent Literature

(1) Szumski, D., Nickel Transmutation and Excess Heat Model using Reversible Thermodynamics, Unpublished manuscript, 2012. ATTACHED TO THIS APPLICATION as appendix I and incorporated by reference into this application
(2) Planck, M. Verhandlunger der Deutschen Physikalischen Gesellschaft, 2, 237, (1900), or in English translation: Planck's Original Papers in Quantum Physics, Volume 1 of Classic Papers in Physics, H. Kangro ed., Wiley, New York (1972).
(3) M. Planck, Eight Lectures in Theoretical Physics-1909, translated by A. P. Wills, Columbia U Press, NY (1915).
(4) Fleischmann, M., S. Pons, M. Hawkins, Electrochemically Induced Nuclear Fusion of Deuterium, J Electroanal. Chem., 261, p. 301 and errata in Vol. 263, 1989.
(5) Miley, G., Patterson, J., “Nuclear Transmutations in thin-Film Nickel Coatings Undergoing Electrolysis”, J. New Energy, vol. 1, no. 3, pp. 5-38, 1996.
(6) Szumski, D. S., Theory of Heat I—Non-equilibrium, Non-quantum Blackbody Radiation Equation Reveals a Second Temperature Scale, Unpublished manuscript, 2012. ATTACHED TO THIS APPLICATION
(7) Gibb, T. R. P., Primary Solid Hydrides, in Progress in Inorganic Chemistry, Vol III, F. A. Cotton(Ed), Interscience Publishers, N Y, 1962.
(8) Cold fusion paper
(9) Essay I
(10) Essay II
(11) Book

I claim:

1. A method of enhancing or maintaining hydrogen loading into a metal hydride lattice by applying an electric current to said lattice.

2. The method of claim 1 wherein said metal hydride lattice is loaded with a greater concentration of hydrogen than could be loaded into said lattice by naturally occurring metal hydride formation.

3. A method of stimulating nuclear transmutations within a metal hydride lattice with a greater concentration of hydrogen than could occur naturally by applying an electric current to said lattice.

4. The method of claim 3 wherein heat energy is created in excess of the electrical energy applied to said metal hydride lattice.

5. The method of claim 3 wherein the concentration of specific nuclear isotopes within said lattice is reduced.

6. The method of claim 3 wherein the concentration of specific nuclear isotopes within said lattice is increased.

7. The method of claim 4 wherein heat production is enhanced by doping said metal hydride lattice with nuclear isotopes which enhance exothermic reactions.

8. The method of claim 6 wherein isotope production is enhanced by doping said metal hydride lattice with nuclear isotopes which enhance specific isotope production.

9. The method of claim 5 wherein isotope reduction is enhanced by doping said metal hydride lattice with nuclear isotopes which enhance specific isotope reductions.

10. The metal hydride lattice of claim 2.

11. The doped metal hydride lattice of claim 7.

12. The doped metal hydride lattice of claim 8.

13. The doped metal hydride lattice of claim 9.
